(19) United States
(12) Patent Application Publication
(10) Pub. No.: US 2025/0276558 A1
(43) Pub. Date: Sep. 4, 2025

(54) AIR VENT APPARATUS FOR VEHICLE

(71) Applicant: HYUNDAI MOBIS CO., LTD., Seoul (KR)

(72) Inventor: Jong Sun WOO, Yongin-si (KR)

(73) Assignee: HYUNDAI MOBIS CO., LTD., Seoul (KR)

(21) Appl. No.: 18/830,012

(22) Filed: Sep. 10, 2024

(30) Foreign Application Priority Data
Feb. 29, 2024 (KR) 10-2024-0029428

(51) Int. Cl. B60H 1/00; B60H 1/34

(52) U.S. Cl. CPC B60H 1/0065; B60H 1/3421; B60H 2001/3471

(57) ABSTRACT

An embodiment discloses an air vent apparatus for a vehicle that includes a first wing extending in the right-left direction at the outlet of a housing, a second wing extending in the up-down direction inside the housing, and a knob assembly that includes a knob body coupled to the first wing and is connected to the second wing, wherein the knob body is disposed in a coupling hole formed by partially cutting the front surface of the first wing inward, and the knob body shifts in the coupling hole between a first state in which the knob body retracts into the first wing and a second state in which the knob body protrudes from the first wing.

### CROSS-REFERENCE TO RELATED APPLICATION

The present application claims the benefit under 35 USC § 119(a) of Korean Patent Application No. 10-2024-0029428, filed on Feb. 29, 2024, in the Korean Intellectual Property Office, the disclosure of which is incorporated herein by reference in its entirety for all purposes.

### BACKGROUND OF THE INVENTION

### Field of the Invention

The present disclosure relates to an air vent apparatus for a vehicle.

### Description of the Related Art

The automotive industry has been putting significant efforts into streamlining the structure of air vents in recent years to adopt next-generation slim cockpit designs. As a part of this endeavor, various attempts have been made to consider both design and functionality.

Wing-type air vents operated by wing knobs are used in most cockpits. However, the exposed wing knobs have the disadvantage of compromising design freedom and interfering with airflow directions, so diverse studies on techniques that minimize or eliminate the wing knobs have been underway.

### SUMMARY OF THE INVENTION

An object of the present invention is to provide an air vent apparatus for a vehicle that allows users to regulate airflow directions through a wing knob as needed while implementing a design where the wing knob is selectively hidden.

The object of the present invention is not limited to the object mentioned above, and other objects not mentioned will be clearly understood by those skilled in the art from the following description.

An air vent apparatus for a vehicle according to an embodiment of the present invention may include a first wing extending in the horizontal direction, a second wing extending in the vertical direction behind the first wing, and a knob assembly that includes a knob body and is coupled to the first wing to the second wing, wherein the knob body may be disposed in a coupling hole positioned at a front surface of the first wing and may be movable relative to the coupling hole between a first state in which the knob body retracts into the first wing and a second state in which the knob body may protrude from the first wing.

The knob assembly may further include a retainer disposed in an accommodating space that extends at least partially through the first wing and the accommodating space may be positioned behind the knob body, an engaging pin disposed in a guide hole that extends through the first wing in a thickness direction between the retainer and a rear surface of the first wing, a binding cover coupled the engaging pin and disposed on the rear surface the first wing, and a rotator rotatably coupled to the binding cover and coupled to the second wing behind the first wing.

The knob body may include a cylindrical first body portion having a curvature matching a curvature of the front surface of the first wing and a plate-shaped second body portion extending in a direction tangential to an outer circumferential surface of the first body portion, wherein the first body portion may have an indicator protruding radially from its outer circumferential surface. The indicator may extend away from the second body portion.

The second body portion may be arranged in a structure that overlaps an upper surface of the first wing in the first state and protrudes forward from the front surface of the first wing in the second state.

The first body portion may rotatably engage a first link bar positioned in the coupling hole and is slidable along the first link bar.

The first link bar may be positioned on the same axis as a rotation shaft that is on opposite sides of the first wing.

The retainer may engage a second link bar provided in the accommodating space and the retainer may be slidable along the second link bar.

The retainer may have a first groove selectively coupled to the indicator on a side facing the first body portion and may be slidable together with the first body portion as the first body portion slides relative to the first wing.

The retainer may have a second groove coupled to the engaging pin on a side facing the engaging pin.

The binding cover may be slidable along a rail groove provided on a rear surface of the first wing.

### BRIEF DESCRIPTION OF THE DRAWINGS

FIG. 1 is a view illustrating an air vent apparatus for a vehicle according to an embodiment of the present invention.

FIG. 2 is a view schematically illustrating a configuration of an air vent apparatus for a vehicle.

FIGS. 3A-3B are views illustrating a first wing in an air vent apparatus for a vehicle.

FIG. 4 is a view illustrating a knob body of a knob assembly in an air vent apparatus for a vehicle.

FIGS. 5A and 5B are views illustrating a knob assembly retainer in an air vent apparatus for a vehicle.

FIGS. 6A and 6B are views illustrating a knob body in a first state.

FIGS. 7A and 7B are views illustrating a knob body in a second state.

FIG. 8 is a view illustrating a binding cover and a rotator of a knob assembly coupled to a first wing.

### DETAILED DESCRIPTION OF THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments of the present invention will be described in detail with reference to the accompanying drawings, and components which are the same or correspond to each other will be denoted by the same or corresponding reference numerals in all drawings, and redundant descriptions will be omitted.

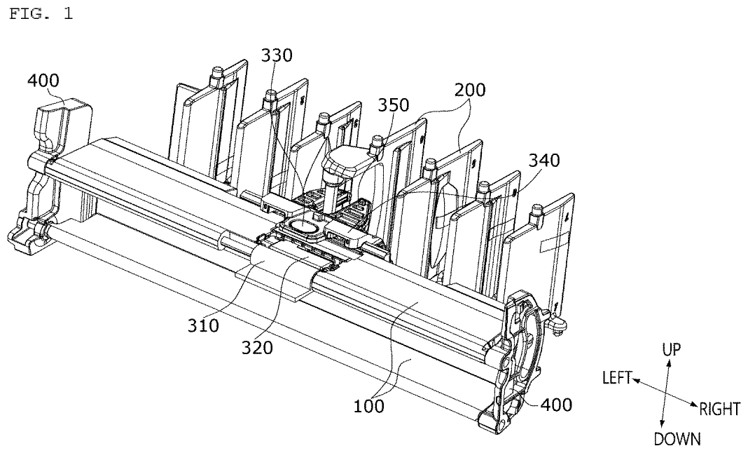

FIGS. 1 to 8 illustrate an air vent apparatus for a vehicle and its configuration according to an embodiment of the present invention.

Drawings show that the air vent apparatus for a vehicle may include a first wing 100, a second wing 200, and a knob assembly 300.

The first wing 100 and the second wing 200 regulating the direction of air supplied to the cabin may be rotatably installed inside an air vent duck (not shown).

The first wing 100 may extend horizontally (in the right-left direction) and rotate up and down. The second wing 200 may extend vertically (in the up-down direction) and rotate right and left on the inner wall of the duct behind the first wing 100. In an embodiment, one or a plurality of first wings (100) may be provided. The present embodiment exemplifies two first wings 100, one of which the knob assembly 300 is connected to, but aspects are not limited thereto. A plurality of second wings (200) may be provided.

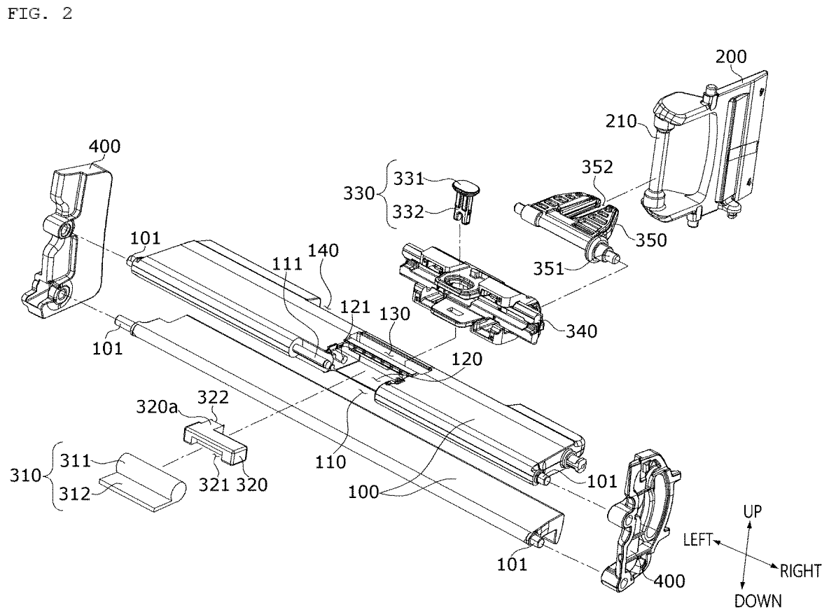

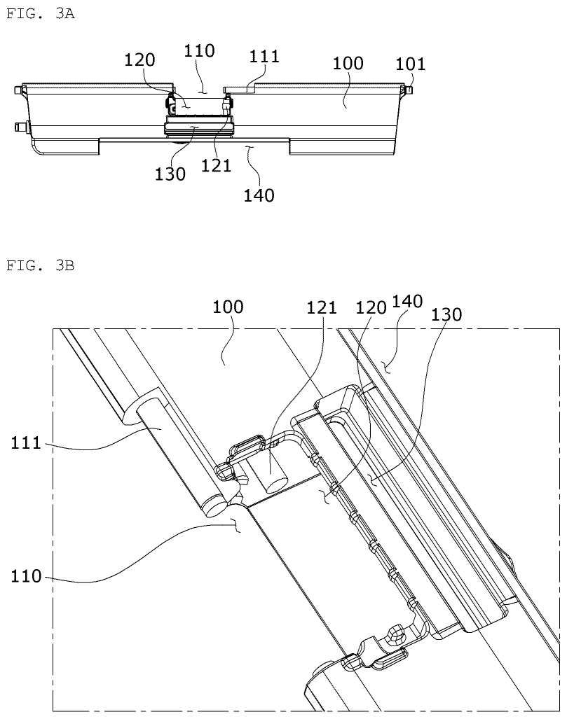

As illustrated in FIGS. 2 and 3A-3B, the first wing 100 connected to the knob assembly 300 may have a coupling hole 110 formed by partially cutting the front surface of the first wing 100 inward. The coupling hole 110 may be formed at the front of the first wing 100, penetrating both the top and bottom portions of the front surface.

A first link bar 111 may be provided in the coupling hole 110. The first link bar 111 may extend in the length direction of the first wing 100 in the coupling hole 110. A knob body 310 of the knob assembly 300 described below may be disposed in the coupling hole 110.

The first wing 100 may have an accommodating space 120 inside. The accommodating space 120 may be connected to the coupling hole 110 in the front and have a structure open to the top surface of the first wing 100.

A second link bar 121 may be provided in the accommodating space 120. The second link bar 121 may extend parallel to the first link bar 111 in the length direction of the first wing 100 in the accommodating space 120. A retainer 320 of the knob assembly 300 described below may be disposed in the accommodating space 120.

The first wing 100 may have a guide hole 130 penetrating the first wing 100 in the thickness direction (up-down direction) between the retainer 320 and the rear surface of the first wing 100. The guide hole 130 may be provided in the form of a slit extending in the length direction of the first wing 100. An engaging pin 330 of the knob assembly 300 described below may be disposed in the guide hole 130.

A rail groove 140 may be provided on the rear surface of the first wing 100, extending in the length direction of the first wing 100.

A rotation shaft 101 may be provided on each side of the first wing 100. The rotation shaft 101 may be rotatably connected to a bracket 400 fixed to a duct, and the first wing 100 can rotate up and down along the rotation shaft 101. The rotation shaft 101 and the first link bar 111 may be positioned on the same axis.

The second wing 200 connected to the knob assembly 300, among the plurality of second wings 200 provided, may be equipped with a support bar 210. The support bar 210 may extend in the up-down right along the second wing 200, i.e., in the thickness direction of the first wing 100.

The knob assembly 300 may be connected to the first wing 100 and the second wing 200. The knob assembly 300 may rotate the first wing 100 up and down and rotate the second wing 200 right and left.

The knob assembly 300 may include the knob body 310, the retainer 320, the engaging pin 330, the binding cover 340, and the rotator 350.

The knob body 310 may be disposed in the coupling hole 110 of the first wing 100. The retainer 320 may be disposed in the accommodating space 120 provided inside the first wing 100 behind the knob body 310. The engaging pin 330 may be disposed in the guide hole 130 penetrating the first wing 100 in the thickness direction between the retainer 320 and the rear surface of the first wing 100.

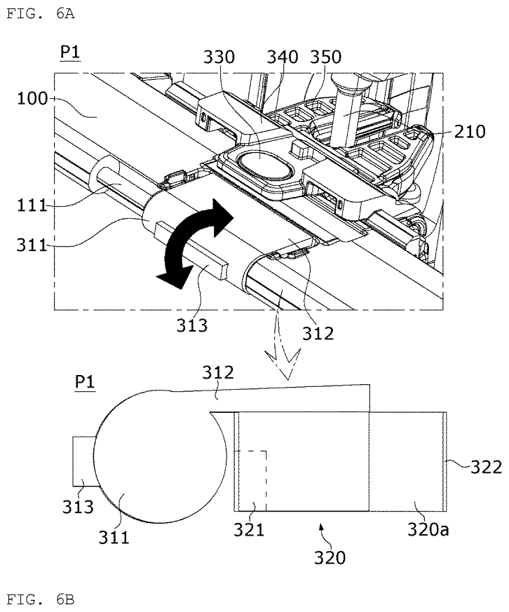

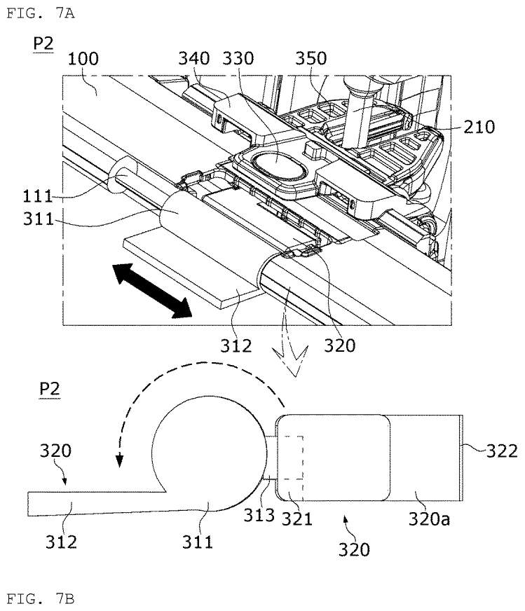

The knob body 310 may shift in the coupling hole 110 between a first state P1 in which the knob body retracts into the first wing 100 and a second state P2 in which the knob body protrudes from the first wing 100 (refer to FIGS. 6A-7B).

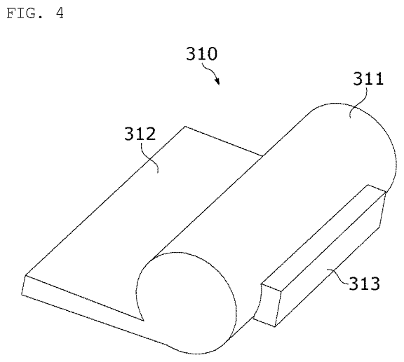

As illustrated in FIG. 4, the knob body 310 may include a cylindrical first body portion 311 having a curvature matching the curvature of a curved surface that the front surface of the first wing 100 has and a plate-shaped second body portion 312 extending in a direction tangential to the outer circumferential surface of the first body portion 311.

The first body portion 311 may have an indicator 313 protruding radially from its outer circumferential surface. The indicator 313 may extend away from the second body portion 312.

The first body portion 311 may rotatably engages the first link bar 111 provided in the coupling hole 110 and slide right and left along the first link bar 111.

The second body portion 312 may be arranged in a structure that overlaps the upper surface of the first wing 100 in the first state P1. At this time, the second body portion 312 may cover the accommodating space 120 open to the upper surface of the first wing 100.

In addition, the second body portion 312 may protrude forward from the front surface of the first wing 100. At this time, the indicator 313 of the first body portion 311 may be disposed to face the accommodating space 120.

In other words, the knob body 310 may shift between the first state P1 and the second state P2 by rotating the first body portion 311, and a design where the second body portion 312 parallels the upper surface of the first wing 100 and thus is hidden when the knob body 310 is in the first state P1 may be implemented. The second body portion 312 may protrude forward from the front surface of the first wing 100 and be exposed when the knob body 310 is in the second state P2.

The retainer 320 may engage the second link bar 121 provided in the accommodating space 120 and slide along the second link bar 121.

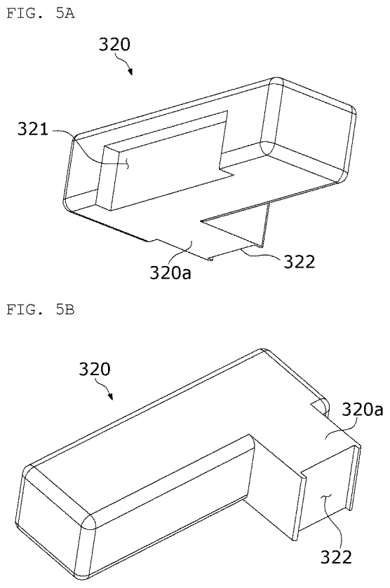

As illustrated in FIG. 5, the retainer 320 may have a first groove 321, to which the indicator 313 is selectively coupled, on a side facing the first body portion 311. In an embodiment, once the first body portion 311 rotates to dispose the knob body 310 into the second state P2, the indicator 313 may be coupled to the first groove 321. As the first body portion 311 slides along the first link bar 111 while the indicator 313 is coupled to the first groove 321, the retainer 320 may slide along the second link bar 121 together with the first body portion 311. In addition, once the first body portion 311 rotates to shift the knob body 310 into the first state P1, the indicator 313 may separate from the first groove 321. And, the retainer 320 is hidden by the second body portion 312.

The retainer 320 may have a second groove 322 coupled to the engaging pin 330 on the other side facing the engaging pin 330. Specifically, the second groove 322 may be formed at the end of a protrusion 320a that partially protrudes from the other side of the retainer 320 toward the engaging pin 330. Here, the other side where the second groove 322 is formed may be the side facing away from the side where the first groove 321 is formed.

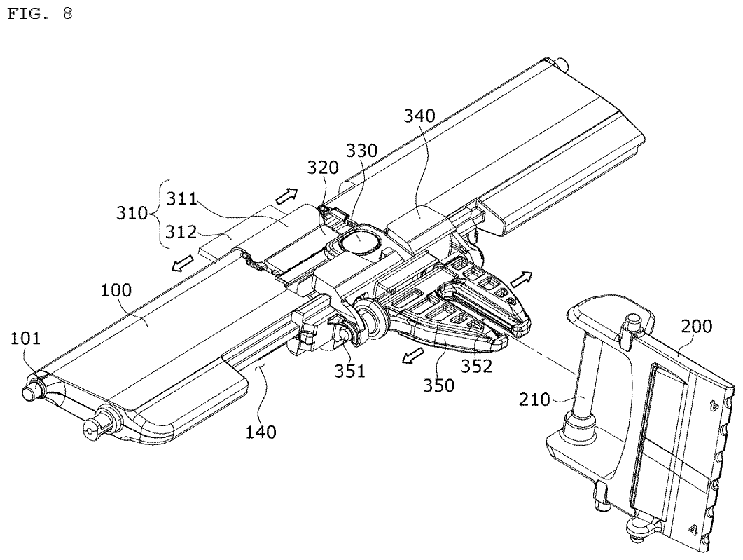

FIGS. 2 and 8 show that the engaging pin 330 penetrates the first wing 100 in the thickness direction in the guide hole 130. The engaging pin 330 may be connected to the binding cover 340 to constrain the binding cover 340 from disengaging from the first wing 100. In other words, the engaging pin is coupled to the binding cover 340 in the guide hole 130 while inserted into the binding cover 340 to prevent the binding cover 340 from disengaging.

In an embodiment, the engaging pin 330 may include a head 331 and a pin body 332 extending from the head 331. The pin body 332 may have a shape matching the second groove 322 for coupling to the second groove 322.

The binding cover 340 may be disposed on the rear surface of the first wing 100 and engage the engaging pin 330.

The binding cover 340 may be provided to be slidable in the length direction of the first wing 100 along the rail groove 140 provided on the rear surface of the first wing 100. Specifically, as the engaging pin 330 coupled to the retainer 320 slides together with the retainer 320 while the binding cover 340 engages the engaging pin 330, the binding cover 340 slides on the rear surface of the first wing 100.

The rotator 350 may be rotatably coupled to the binding cover 340 and be connected to the second wing 200 behind the first wing 100.

The rotator 350 may have a hinge shaft 351 rotatably coupled to the binding cover 340 and a slot hole 352 into which the support bar 210 of the second wing 200 is inserted for coupling. As a result, as the binding cover 340 slides right and left on the rear surface of the first wing 100, rotator 350 may rotate the second wing 200 right and left while sliding together with the binding cover 340.

As described above, the embodiment of the present invention may implement a design where the knob assembly 300 provided in the first wing 100 selectively shifts between the first state P1 where the knob body 310 retracts into the first wing 100 and the second state P2 where the knob body 310 protrudes from the first wing 100.

As a result, as illustrated in FIGS. 6A-6B, vehicle occupants may rotate the first wing 100 up and down through the indicator 313 protruding toward the cabin when the knob body 310 is in the first state P1. And, as illustrated in FIGS. 7A-7B, vehicle occupants may rotate the second wing 200 right and left through the second body portion 312 protruding toward the cabin when the knob body 310 is in the second state P2. In other words, the embodiment may be configured to expose the second body portion 312 of the knob body 310, which retracts in hiding, only when needed.

In addition, since the knob body 310 does not protrude in the thickness direction of the first wing 100, the air moving along the surface of the first wing 100 can be supplied into the cabin without encountering much resistance so that the airflow directions can be precisely regulated and the air volume performance can be improved.

Therefore, in a conventional structure where the first wing is fastened penetrating through the wing knob and having the wing knob surround the first wing, issues such as changes in the airflow directions caused by the wing knob blocking the air and consequent air volume loss do not arise in the present invention.

In addition, design constraints of the slim air vent may be alleviated and the design continuity may be maintained by the first wing 100 and its surrounding decorative garnish exposed to the cabin.

According to the embodiment of the present invention, an air vent apparatus for a vehicle that allows users to regulate the airflow directions through a wing knob as needed while implementing a design where the wing knob is selectively hidden may be provided.

The effects of the present invention are not limited to the effects described above, and other effects not mentioned will be clearly understood by those skilled in the art from the following description of the patent claims.

While the foregoing description has focused on specific embodiments of the present invention, it should be understood that various modifications and changes can be made by those skilled in the art without departing from the spirit and scope of the invention as defined in the appended claims. Furthermore, any distinctions arising from such modifications and changes should be understood to fall within the scope of the present invention as delineated in the appended claims.

What is claimed is:

1. An air vent apparatus for a vehicle, comprising:
a first wing extending horizontally;
a second wing extending vertically behind the first wing; and
a knob assembly including a knob body and is coupled to the first wing and to the second wing, wherein
the knob body is disposed in a coupling hole positioned at a front surface of the first wing, and
the knob body being movable relative to the coupling hole between a first state in which the knob body retracts into the first wing and a second state in which the knob body protrudes from the first wing.

2. The air vent apparatus for a vehicle of claim 1, wherein the knob assembly further comprises:
a retainer disposed in an accommodating space that extends at least partially through the first wing, wherein the accommodating space is positioned behind the knob body;
an engaging pin disposed in a guide hole that extends through the first wing in a thickness direction between the retainer and a rear surface of the first wing;
a binding cover coupled to the engaging pin and disposed on the rear surface of the first wing; and
a rotator rotatably coupled to the binding cover and coupled to the second wing behind the first wing.

3. The air vent apparatus for a vehicle of claim 2, wherein, the knob body includes a cylindrical first body portion having a curvature matching a curvature of the front surface of the first wing and a plate-shaped second body portion extending in a direction tangential to an outer circumferential surface of the first body portion, and
wherein the first body portion has an indicator protruding radially from its outer circumferential surface, and the indicator extends away from the second body portion.

4. The air vent apparatus for a vehicle of claim 3, wherein the second body portion is arranged in a structure that overlaps an upper surface of the first wing in the first state and protrudes forward from the front surface of the first wing in the second state.

5. The air vent apparatus for a vehicle of claim 3, wherein the first body portion rotatably engages a first link bar positioned in the coupling hole and is slidable along the first link bar.

6. The air vent apparatus for a vehicle of claim 5, wherein the first link bar is positioned on the same axis as a rotation shaft that is provided on opposite sides of the first wing.

7. The air vent apparatus for a vehicle of claim 3, wherein the retainer engages a second link bar provided in the accommodating space and the retainer is slidable along the second link bar.

8. The air vent apparatus for a vehicle of claim 7, wherein the retainer has a first groove selectively coupled to the indicator on a side facing the first body portion and is slidable together with the first body portion as the first body portion slides relative to the first wing.

9. The air vent apparatus for a vehicle of claim 7, wherein the retainer has a second groove coupled to the engaging pin on a side facing the engaging pin.

10. The air vent apparatus for a vehicle of claim 2, wherein the binding cover is slidable along a rail groove provided on a rear surface of the first wing.
